(19) United States
(12) Patent Application Publication
(10) Pub. No.: US 2008/0202344 A1
(43) Pub. Date: Aug. 28, 2008

(54) Oil fog separator

(75) Inventor: Chieh-Yuan Cheng, Taichung (TW)

Correspondence Address: BRUCE H. TROXELL, SUITE 1404, 5205 LEESBURG PIKE, FALLS CHURCH, VA, 22041, US

(73) Assignee: San Ford Machinery Co., Ltd.

(21) Appl. No.: 11/711,878

(22) Filed: Feb. 28, 2007

(51) Int. Cl. B01D 53/02

(52) U.S. Cl. 96/152; 96/154

(57) ABSTRACT

An oil fog separator includes a filtering chamber, a filtering device, and a gas-exhausting chamber. The filtering chamber communicates with the exhausting chamber by an air hole, having an accommodating space and a lower portion separated by an intermediate wall from the accommodating space and having an inlet for oil fog to enter. The filtering device is installed in the accommodating space, composed of a filter and a vibrating motor. Then the filter filters oil fog mixed in the air sucked in for the first time, and liquid oil produced is exhausted by the vibrating motor. Filtered oil fog by the filter is then sucked by a vane-wheel in the gas exhausting chamber, and then led in the odor treating device for filtering for the second time to become completely clean gas to be exhausted out in the air.

### BACKGROUND OF THE INVENTION

1. Field of the Invention

This invention relates to a separator, particularly to one for collecting and filtering such toxic substances as oil fog, filthy gas, etc.

2. Description of the Prior Art

In order to prevent tools from getting too hot in processing metal works in the metal mechanical industry, lubricating oil or coolant is incessantly being sprayed on a metal work being processed, so sprayed lubricating oil or coolant may partly become smoke and to float and pervade in the air, mingling with miscellaneous substances in the air or steel waste, and thus oil fog is produced. Then the working environment is to be polluted, indirectly affecting the quality and efficiency of the work, so it is common to use a cover above a machine, and an oil fog filter additional provided for leading oil fog to flow in the filter via the cover, and then properly filtered by a filter sheet therein and then exhausted out as clean air, with the air quality in the working environment improved. Nevertheless, there is always a large quantity of contaminated oil contained in the oil fog absorbed in the oil fog filter, so the filter core in the interior of the filter may be clogged by a large amount of contaminated oil blocked on the filter core. Then a worker has to frequently take off the clogged filter core and replace with a new one, resulting in inconvenience in using.

### SUMMARY OF THE INVENTION

The oil fog separator according to the invention is featured by a filtering chamber, a filtering device, and a gas-exhausting chamber. The filtering chamber communicates with the gas-exhausting chamber. The filtering chamber has an accommodating space in an upper portion and a lower portion separated by an intermediate wall, with a sidewise inlet in a vertical side of the lower portion, an outlet in the intermediate wall and an oil-exhausting hole in the bottom of the filtering chamber. The filtering device is installed in the accommodating space, composed of a filter and a vibrating motor. The filter is cylindrical, having several filtering layers, with the vibrating motor fixed on an upper side of the filter for vibrating the filter so that liquid oil produced after filtering of oil fog by the filter may flow down through the oil-exhausting hole into an oil tank to be collected and recycled. After the filter is used for a certain period and comparatively has oil, it can be replaced with a new one, net let it totally clogged. Then a vane-wheel fixed on an outer vertical wall of the exhausting chamber can suck filtered oil fog into the gas-exhausting chamber and treated by an odor-treating device fixed on the exhausting chamber to become completely clean gas to be exhausted out in the air.

### BRIEF DESCRIPTION OF DRAWINGS

This invention will be better understood by referring to the accompanying drawings, wherein:

FIG. 1 is a front view of a preferred embodiment of an oil fog separator in the present invention;

FIG. 2 is an exploded perspective view of the preferred embodiment of an oil fog separator in the present invention;

FIG. 3 is a perspective view of a filter in the preferred embodiment of an oil fog separator in the present invention; and,

FIG. 4 is a side cross-sectional view of the preferred embodiment of an oil fog separator in the present invention, showing it under using condition.

### DETAILED DESCRIPTION OF THE PREFERRED EMBODIMENT

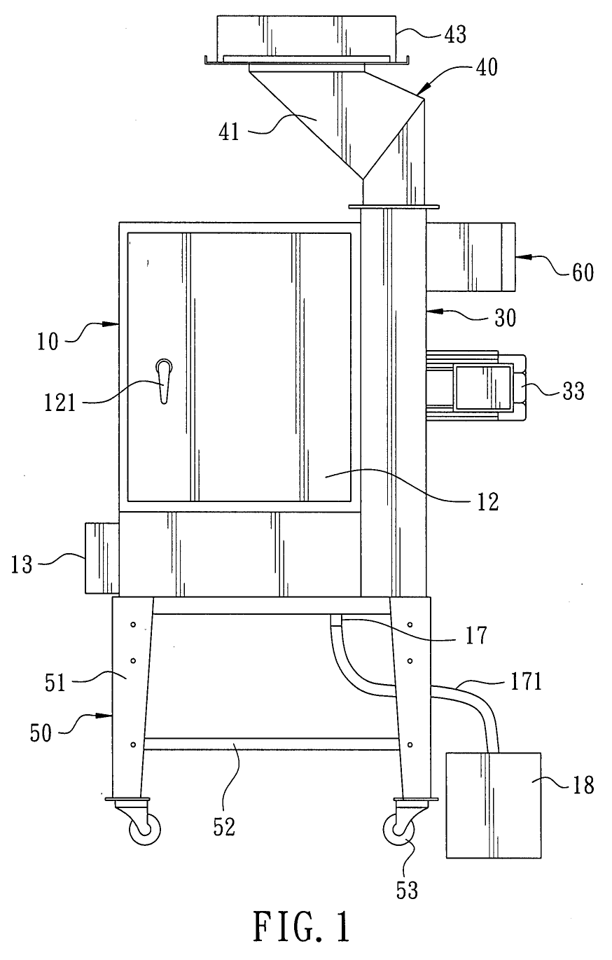

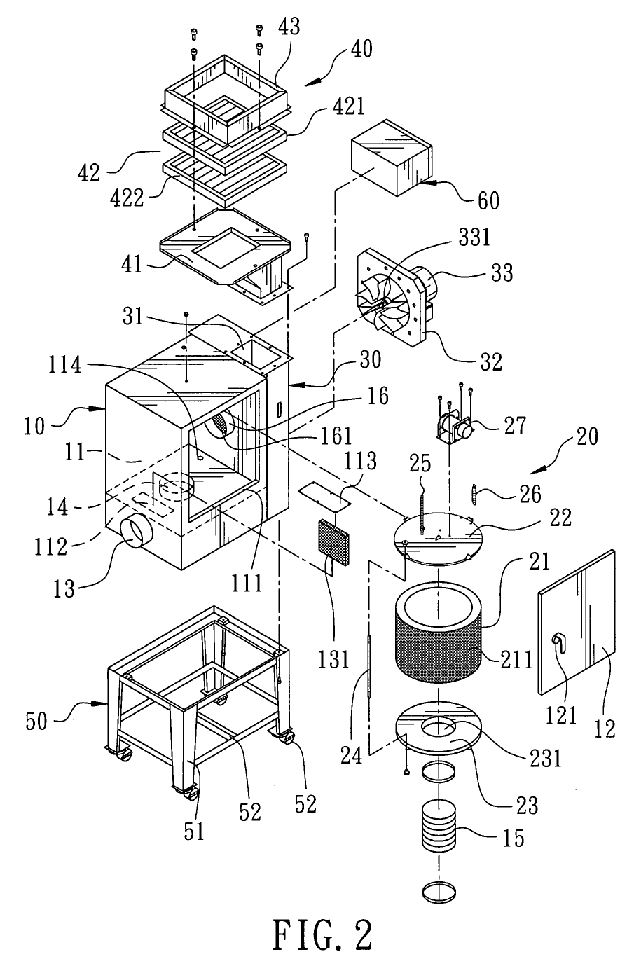

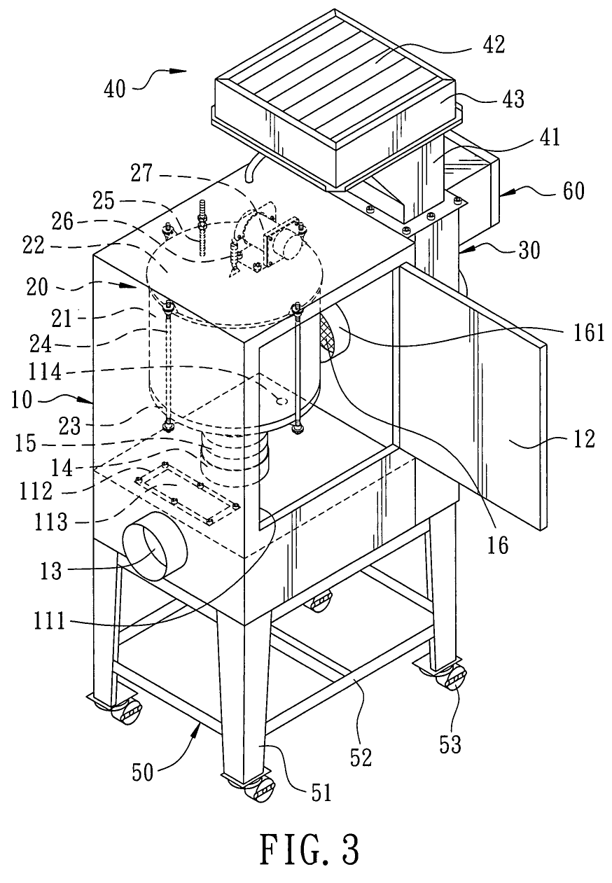

A preferred embodiment of an oil fog separator in the present invention, as shown in FIGS. 1, 2 and 3, includes a filtering chamber 10, a filtering device 20, an exhausting room 30 and an odor-treating device 40 as main components combined together.

The filtering chamber 10 is provided with an accommodating space 11, an opening 111 formed in a front side of the accommodating space 10, a doorplate 12 pivotally connected to one side of the opening 111, a grip 121 for opening and shutting the filtering chamber 10 fixed on the doorplate 12, an inlet 13 formed projecting outward sidewise from one vertical side of a lower portion of the filtering chamber 10, with an intermediate wall separating the accommodating space 11 from the lower portion. The inlet 13 extends through the interior of the lower portion of the filtering chamber 10, and an outlet 14 is formed near a center portion of the intermediate wall and opens upward, with an elastic tube 15 fitted with the outlet 14. Further, a filter sheet 131 is affixed in the inlet 13 for blocking large pieces of scraps from entering the lower portion of the filtering chamber 10. Furthermore, a recess 112 is provided in the intermediate wall between the inlet 13 and the outlet 14 for storing and taking out the filtering sheet 131 and closed by a cap 113, and an air hole 16 is formed at a proper location of the side opposite to the side with the inlet 13 in the filtering chamber 10, with a steel net 161 installed in the air hole 16. Further, a small hole 114 is provided in the intermediate wall of the filtering chamber 10, and an exhausting hole 17 is bored in the intermediate wall of the filtering chamber 10, with one end of an exhausting tube 171 fitted with the exhausting hole 17 and with the other end of the exhausting tube 171 connected with an oil tank 18.

The filtering device 20 is installed in the accommodating space 11, composed of a filter 21 and a vibrating motor 27, and the filter is shaped cylindrical and provided with a stainless steel layer 211 in an outer circumference and plural inner filtering layers made of various materials such as polyester fiber, glass fiber, etc. Further, the filter 21 is sandwiched between an upper cap 22 and a lower cap 23, with a ring 231 fixed under the lower cap 23. Then the elastic tube 15 fitted around the outlet 14 with its upper end is fitted with the ring 231 so the filter 21 may be connected to the outlet 14. Further, the filter 21 is tightly connected to the upper wall of the accommodating space 11 by a bar 25 for hanging, and a spring 26 is positioned on the upper cap 22 also to hang the filter 21 in the accommodating space 11. The vibrating motor 27 is fixed on the filter 21 to vibrate the filter 21 and then the filter 21 subsequently sways the elastic tube 15 so that the filter 21 does not collide with the separator body and filters dirty oil fog sucked therein for at first, and then the dirty fog becomes liquid oil to flow down and out of the exhausting hole 17. Additionally the oil exhausting tube 171 has one end connected with the exhausting hole 17 and the other end connected to the oil tank 18, which stores the oil recycled.

The gas-exhausting chamber 30 communicates with the accommodating space 11 via the air hole 16. The gas-exhausting chamber 30 has an exhausting hole 31 in an upper wall, and a vane-wheel 32 installed inside and pivotally connected to a shaft 331 of a motor 33. The motor 33 drives the vane-wheel 32 to suck filtered oil fog into the gas-exhausting chamber 30 and then out of the exhausting hole 31.

The odor treating device 40 is installed on the gas exhausting hole 31 of the exhausting chamber 30, provided with an outlet tube 41, at least one filter net 42 and a frame 43. In this embodiment, the outlet tube 41 is of a flannel shape, and a paper-framed primary filter net 421 and a paper-framed secondary active-carbon filter net 422 are fixed on the air outlet tube 41, and a second frame 43 is fixed on the active-carbon filter net 42, letting dirty oil gas to flow and be filtered for the second time through the active-carbon filter net 42, becoming completely clean gas to be exhausted out in the air.

Moreover, a frame stand 50 is provided under the oil fog separator for supporting it, composed of four feet 51 at four corners, a placing board 52 positioned inside the frame stand and combined with the lower portion of the four feet 51, and each foot 51 fixed with a roller 52 to enable the oil fog separator to stand movably on the ground. Further, a control box 60 is provided at one side of the oil fog separator, having plural switches for operating the separator.

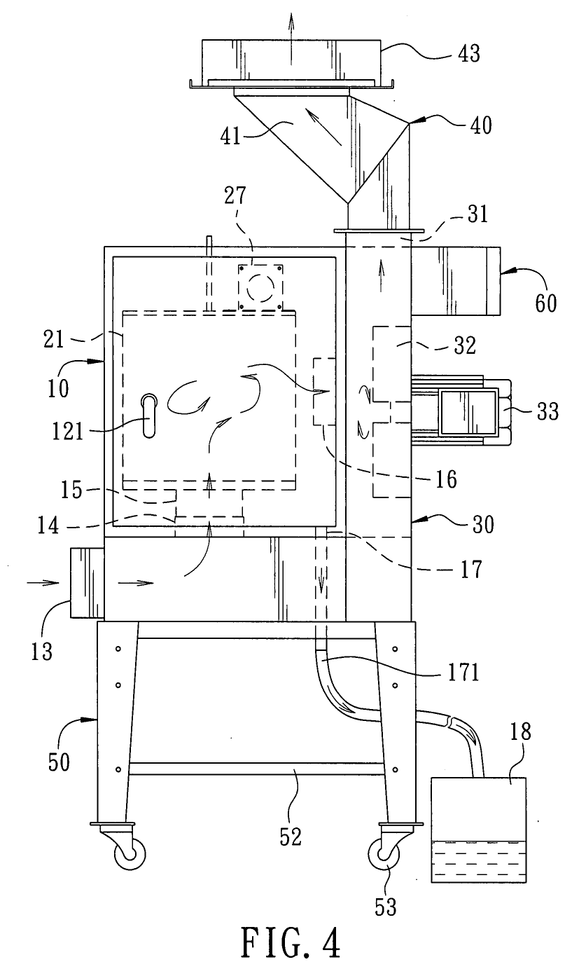

In order to let the structure of the invention understood more clearly, as shown in FIG. 4, the control box 60 is used to start the motor 33, which then drives the vane-wheel 32 for sucking oil fog mixed in the air to enter the inlet 13 with the filter sheet 131 for blocking large pieces of waste substance from entering there. Then the oil fog with air flows through the outlet 14 in the elastic tube 15 and then into the filter 21, wherein filtering is carried out by the filter 21 for at first, with every large or small particles contained in the oil fog filtered and removed by the filtering material of the filter 21. Then liquid oil produced by filtering of the filter 21 by means of vibration of the vibration motor 27 may flow out of the oil-exhausting hole 17 and into the oil tank 18, attaining the object of collecting and recycling oil. The dirty oil fog already filtered by the filter 21 is again sucked by the vane-wheel 32 into the air hole 16 and into the gas exhausting chamber 30 and then receives the second filtering by the primary paper-framed filter net 421 and the secondary paper-framed active carbon-filter net 422 of the air exhausting tube 41, becoming complete clean gas to be exhausted out in the air, so the quality of the air around the working environment can be kept clean. The filtering sheet 131 is easily replaced with a new one by opening the door 12, with the seal cap 113 removed.

Next, the advantages of the invention are to be described as below.
1. The filter, the filtering sheet and the filtering net in the oil fog separator can remove every large or small particles contained in oil fog mixed in the air step by step, with good efficiency, and with vibration of the vibration motor, liquid oil produced after filtered flows down and out of the outlet and then is collected in the oil tank to attain the object of collecting and recycling oil. Thus the separator is not necessary to wash often, by replacing the filtering material, not letting oily substance remained on the filtering material for long, enhancing the service life of the separator.
2. The vane-wheel and the motor are not to directly collide with dirty oil fog, with the filtering chamber and the gas-exhausting chamber communicated with each other by an air hole, preventing explosion or fire from happening.
3. The filter is composed of the outer stainless steel layer protecting the inner filtering layers so that it is avoided from hitting by iron waste or miscellaneous bits, with the filtering material prolonged in the service life.
4. Provision of the odor-treating device can filter oil fog mixed with air for the second time to purify oil fog completely to become clean gas to be exhausted out in the air, maintaining good quality of the air around the working environment.
5. The doorplate enables easy inspection of the filtering chamber and the filtering sheet, so it is very convenient to know when to wash or replace them if necessary.
6. The oil fog separator can be applied to various CNC controlled machines, lathes, and general processing machines for factories.

While the preferred embodiment of the invention has been described above, it will be recognized that various modifications may be made therein and the appended claims are intended to cover all such modifications that may fall within the spirit and scope of the invention.

What is claimed is:

1. An oil fog separator comprising:
a filtering chamber provided with an accommodating space, an inlet formed sidewise in a side of a lower portion of said filtering chamber for exterior oil fog to flow through, said inlet communicating through said lower portion, an outlet formed upward in an intermediate wall separating said accommodating space from said lower portion, an air hole formed in a side opposite to a side with said inlet, and an oil outlet formed in a center portion of said intermediate wall;
a filtering device installed in said accommodating space and composed of an filter and a vibrating motor, said filter shaped cylindrical and having several annular layers of filtering material and a bottom connected to the oil outlet, a shaft having a lower end fixed on an upper side of said filter and an upper end fixed with an upper wall of said accommodating space for hanging said filter, at least a spring connected between said upper side of said filter and said upper wall of said accommodating space for also hanging said filter, said vibrating motor fixed on the upper side of said filter for vibrating said filter; and,
a gas exhausting chamber communicating with said filtering chamber at a side opposite to the side of said air hole, said gas exhausting chamber also communicating with said accommodating space via said air hole, a hole formed in an upper wall of said gas exhausting chamber, a vane-wheel installed in said gas exhausting chamber, a motor installed in said exhausting chamber and having its shaft connected pivotally with said vane-wheel so that said vane-wheel sucks filtered oil fog by said filter into said gas exhausting chamber and then out into the air.

2. The oil fog separator as claimed in claim 1, wherein an odor treating device is installed on said gas exhausting hole of said gas exhausting chamber, provided with an air exhausting tube, at least a filter net and a frame, a filter net laid on said air exhausting tube, and said frame affixed on said filter net.

3. The oil fog separator as claimed in claim 1, wherein said filter is provided with a stainless steel net layer in an outer circumference, and several inner filtering layers made of polyester, glass fiber, etc. inside said stainless steel net layer.

4. The oil fog separator as claimed in claim 1, wherein said filtering chamber is provided with an opening in a front side, and a doorplate is pivotally connected to one side of said opening for opening and closing said filtering chamber.

5. The oil fog separator as claimed in claim 1, wherein said inlet is provided with a filtering sheet for blocking comparatively large pieces of waste from entering.

6. The oil fog separator as claimed in claim 1, wherein said lower portion of said accommodating space has a recess formed in said intermediate wall for putting and taking out a filtering sheet therein, with a cap closed removably on said recess.

7. The oil fog separator as claimed in claim 1, wherein said oil exhausting hole is affixed with an oil exhausting tube, which has the other end connected to a oil tank.

8. The oil fog separator as claimed in claim 1, wherein said outlet is affixed with an elastic tube, so that said elastic tube may be swayed by said filter, preventing said separator from vibrated.

9. The oil fog separator as claimed in claim 1, wherein said filter is sandwiched by an upper cap and a lower cap at its upper side and its lower side respectively, with plural fixing bars fixed with an outer circumference of said upper cap and said lower cap.

10. The oil fog separator as claimed in claim 2, wherein said filter net of said odor treating device is a primary paper-framed filter net and a secondary paper-framed active-carbon filter net.

11. The oil fog separator as claimed in claim 1, wherein a frame stand is provided under said oil fog separator, having four feet at four corners, and a roller is fixed under each said foot, enabling said separator to move around on the ground.

12. The oil fog separator as claimed in claim 1, wherein a control box is installed at one side of said separator, provided inside with plural buttons for operating said separator.
